(19) United States
(12) Patent Application Publication
(10) Pub. No.: US 2012/0183648 A1
(43) Pub. Date: Jul. 19, 2012

(54) SWEETENER COMPOSITION

(75) Inventors: Buxiang Sun, Guilin (CN); Lingzhi Tang, Guilin (CN); Wei Lu, Guilin (CN); Zhenpeng Chen, Guilin (CN); Yongji Yi, Guilin (CN); Bofeng Wu, Guilin (CN)

(73) Assignee: GUILIN LAYN NATURAL INGREDIENTS CORP., Guilin, Guangxi (CN)

(21) Appl. No.: 13/498,288

(22) PCT Filed: Aug. 20, 2010
(86) PCT No.: PCT/CN2010/076217

§ 371 Date: Mar. 26, 2012

(30) Foreign Application Priority Data
Dec. 2, 2009 (CN) 200910114606.7

(51) Int. Cl. A23L 1/221; A23L 1/308; A23L 1/302

(52) U.S. Cl. 426/72; 426/548

(57) ABSTRACT

A sweetener composition is provided, formed with natural plant extracts including Luo Han Guo fruit extract and sweet stevia extract, and neohesperidin dihydrochalcone (NHDC) as raw materials at a scientific and sound mixing ratio such that the disadvantage of having a strong aftertaste of water is eliminated, and the Chinese herbal medicine taste of the Luo Han Guo fruit and the bitter aftertaste of stevia sugar are effectively shielded. The sweetener composition successfully removes the Chinese herbal medicine taste of Luo Han Guo fruit and the bitter aftertaste of stevia sugar while fully exerting the herbal fresh and sweet taste of the Luo Han Guo fruit extract and the sweet stevia extract, and perfectly combines the sweet aftertaste of mogrosides, so that the sweet taste is maintained and the taste is good, and the sweetener composition of the present invention is well accepted by consumers.

### FIELD OF THE PRESENT INVENTION

The present invention relates to an additive, and more particularly to a sweetener composition.

### BACKGROUND OF THE PRESENT INVENTION

As it is well known that sugar is one of the necessities in human life, and the demand for sugar accounts for a quite large proportion in the food industry. Sucrose is the main source of sugar consumed in China, due to its pure sweet taste, sucrose is very popular among consumers. However, due to its high calorific value of sucrose, excessive consumption increases risk of diseases such as diabetes, obesity and hyperglycemia. In order to reduce the chance of such negative impact caused by the consumption of sugar, non-sugar sweeteners were introduced. Currently, majority of the non-sugar sweeteners that have been discovered and used include the following:
1. Synthetic sweeteners: mainly include saccharin, which are a type of non-calorific sweetener, containing a sweetness of 500 times that of sucrose. However, due to the risk of causing cancers, the synthetic sweeteners disappeared quickly.
2. Sugar alcohol sweeteners: mainly include xylitol, sorbitol, maltitol, etc. However, intake of this type of sweeteners must be in appropriate amount, or it may leads to diarrhea, or more severely functional gastrointestinal disorders.
3. Natural sweeteners: mainly include Glycyrrhizic glucoside, steviosides, momordica-glycosides etc, which are extracted from natural plants, and having the advantages of being safe, improved sweetness, low in calories, and having certain degree of functional effects.
4. Amino acid derivative sweeteners: mainly include aspartame, having similar level of calorific value as sugar, and a caloricity generated at a normal dosage that can be ignored due to the high sweetness and thus these are actually a type of non-caloric sweeteners. However, Aspartame has side effects and lawsuits were reported. In 1997, among numerous users of aspartame sweeteners, severe toxic reactions and injuries, such as convulsions, eye damages and blindness, trance, severe migraine, dithered, depression, and common cold were reported.

In contrast, conforming to consumer health consciousness and growing trend, natural sweeteners such as steviosides and mogrosides are becoming more and more popular. The sweetness of steviosides is 200-350 times of that of sucrose, but the calorific value is merely 1/300 of that of sucrose. It is proven by a large number of drug experiments that steviosides have no toxic side effects and contain no carcinogens, and have increased safety without any harmful effect discovered so far. Regular intake of steviosides can achieve the effect of preventing hypertension, diabetes, obesity, heart disease, dental decay and other diseases, and therefore, steviosides is a type of ideal sweetener that is capable of replacing sucrose. The sweet taste of steviosides is similar to that of granulated sugar, but an unpleasant taste of bitterness and astringency remains as an aftertaste. Therefore, it is preferred that a sweetener does not contain a large amount of steviosides. The sweetness of mogrosides is about 300 times of that of sucrose, and most of the sweet taste is attributed to mogroside V. However, mogrosides are mostly obtained in the form of a powder extract, and the powder extract of Luo Han Guo fruit has a unique Chinese herbal medicine taste of the Luo Han Guo fruit. When the Luo Han Guo fruit extract is used in foods and beverages as a sweetener, a suppressing ingredient is generally needed to suppress the Chinese herbal medicine taste of the Luo Han Guo fruit extract.

Neohesperidin dihydrochalcone (NHDC) is a flavonoid derivative obtained from extracts of plants such as mandarin, orange and grapefruit through fermentation. The substance has a high sweetness which is about 1500-1800 times of that of sucrose, and has a fresh taste and a long-lasting aftertaste without the unpleasant taste of saccharin or steviosides after use. Moreover, it is found through studies that, NHDC has an excellent efficacy in improving the flavor, plus the characteristics of slightly late exertion and long maintenance of the sweet taste, NHDC is used as a unique additive in combination with other sweeteners to improve and enhance the flavor of foods and beverages for overall improvement. NHDC also has a very excellent bitterness suppressing effect. The sweet taste of NHDC is similar to that of fruit, and is characterized in that the sweet taste is slowly exerted, the aftertaste is maintained for a longer period of time, and the sweet taste is fresh and pleasant, so NHDC can effectively reduce the degree of sensitivity of human body to possible bitterness of the beverages or drugs. Although an extremely small amount of NHDC brings a very high sweet taste, when NHDC is dissolved in water as a sweetener alone, due to the very low solubility of NHDC in water, the compatibility of NHDC and water molecules is poor, so that the sweet solution has a higher water taste, and the sweet taste is not strong enough to suppress the water taste.

Currently, steviosides or the Luo Han Guo fruit extract is respectively formulated with other ingredients to produce a sweetener. For example, in Chinese Patent Publication No. CN1314102, a sweetener is disclosed, which contains steviosides, sucrose, potassium dihydrogen phosphate, malic acid and a natural spices at a weight ratio (%) of 1-3:4-10:0.03-0.10:0.04-0.08:0.01-0.1. Merely an extremely small amount of the sweetener of this invention can achieve the sweetness of the taste required. However, the main ingredient of the sweetener of this invention is still sucrose, so the calorific value of the sweetener is still high. Moreover, no ingredient of the sweetener can effectively suppress the bitterness and astringency of steviosides, so the sweetener still has the aftertaste of bitterness and astringency of steviosides, resulting in an unpleasant taste. Furthermore, in Chinese Patent Publication No. CN101214040, a Luo Han Guo fruit sweetener is disclosed, which mainly contains a dry whole fruit extract powder of Luo Han Guo fruit and Luo Han Guo fruit saponins at a weight ratio of 1-9:1-9. The sweetener of this invention has the advantage of high sweetness of the Luo Han Guo fruit saponins, but no ingredient of the sweetener can effectively suppress the Chinese herbal medicine taste of the dry whole fruit extract powder of Luo Han Guo fruit and the Luo Han Guo fruit saponins, so that the sweetener is not well accepted by people that does not enjoy the Chinese herbal medicine taste of the Luo Han Guo fruit.

Therefore, a heretofore unaddressed need exists in the art to address the aforementioned deficiencies and inadequacies.

### SUMMARY OF THE PRESENT INVENTION

In one aspect, the present invention relates to a sweetener composition, which is formed with extracts of pure natural plants sweet stevia, Luo Han Guo fruit and shaddock as raw materials at a scientific and sound mixing ratio, and can successfully remove the bitter aftertaste of stevia sugar and the Chinese herbal medicine taste of Luo Han Guo fruit while fully exerting the herbal fresh and sweet taste of the raw materials.

The sweetener composition of the present invention, based on the weight percentage, includes:

a Luo Han Guo fruit extract, 0.1-80%;

a sweet stevia extract, 0.1-60%;

NHDC, 0.001-0.05%; and

an adjuvant, 1-80%,

where the weight content of the Luo Han Guo fruit extract, based on mogroside V, is 1-95%; and the weight content of the sweet stevia extract, based on steviosides, is 50-95%.

In one embodiment, the preferred weight contents of the ingredients are:

the Luo Han Guo fruit extract, 1-60%;

the sweet stevia extract, 1-40%;

NHDC, 0.001-0.03%; and

the adjuvant, 10-80%.

In another embodiment, a further preferred weight contents of the ingredients are:

the Luo Han Guo fruit extract, 5-30%;

the sweet stevia extract, 3-25%;

NHDC, 0.001-0.02%; and

the adjuvant, 45-80%.

In yet another embodiment, a more preferred weight contents of the ingredients are:

the Luo Han Guo fruit extract, 20%;

the sweet stevia extract, 15%;

NHDC, 0.01%; and

the adjuvant, 64.99%.

In the formulations, the Luo Han Guo fruit extract is an existing extract obtained from the Luo Han Guo fruit through conventional methods, including, for example, Luo Han Guo fruit juice powder, mogrosides, and mogroside V.

The sweet stevia extract is an extract obtained from the asteraceae herb sweet stevia through existing conventional methods.

The adjuvant includes at least one of inulin, modified starch, a water-soluble dietary fiber, and may further include an appropriate amount of at lease one of citric acid, Vitamin C, sugar alcohols and other spices. When the adjuvant is a mixture of two or more substances mentioned above, the substances may be mixed at a plurality of predetermined ratios.

Compared with the prior art, the natural plant extracts according to one embodiment of the present invention, namely, the Luo Han Guo fruit extract and the sweet stevia extract, are used as main ingredients. A predetermined amount of NHDC is also added, so that the disadvantage of having insufficient sweet taste when NHDC is used alone as a sweetener is eliminated, and the Chinese herbal medicine taste of the Luo Han Guo fruit and the bitter aftertaste of stevia sugar are effectively suppressed by using the excellent bitterness and astringency suppressing characteristic of NHDC. Therefore, the sweetener composition of the present invention can successfully remove the Chinese herbal medicine taste of Luo Han Guo fruit and the bitter aftertaste of stevia sugar while fully exerting the herbal fresh and sweet taste of the Luo Han Guo fruit extract and the sweet stevia extract, and perfectly combine the sweet aftertaste of mogrosides. The sweet taste is maintained longer and the taste is better. The sweetener composition of the present invention is well accepted by consumers. Moreover, the sweetener composition of the present invention is a natural and nutrient-rich product with low production costs.

### BRIEF DESCRIPTION OF THE DRAWING

Further features and benefits of the present invention will be apparent from a detailed description of preferred embodiments thereof taken in conjunction with the following drawing:

FIG. 1 is a sweet taste analysis diagram for comparing sweet tastes of steviosides (95 wt %), mogroside V (95 wt %) and a sweeter composition prepared in Embodiment 4 as Samples 1, 2 and 3, with the sweetness of a 5% sucrose solution as a standard, wherein [symbol] represents the standard, [symbol] represent Sample 1, [symbol] represents Sample 2, and [symbol] represents Sample 3.

### DETAILED DESCRIPTION OF THE PRESENT INVENTION

Prior to a detailed description of the present invention(s), the following definitions are provided as an aid to understanding the subject matter and terminology of aspects of the present invention(s), and not necessarily limiting of the present invention(s), which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

Embodiments of the present invention are described below with reference to the accompanying drawing.

### Embodiment 1

A total of 1000 kg sweetener composition was formulated. Raw materials were weighted according to the following weight percentages:
a Luo Han Guo fruit extract (containing 20 wt % of mogroside V), 50%;
a sweet stevia extract (containing 50 wt % of steviosides), 20%;
NHDC, 0.001%; and
inulin, 29.999%.

The weighted raw materials were mixed, stirred, crushed to 80 meshes and then packaged.

### Embodiment 2

A total of 1000 kg sweetener composition was formulated. Raw materials were weighted according to the following weight percentages:
a Luo Han Guo fruit juice powder (containing 3 wt % of mogroside V), 80%;
a sweet stevia extract (containing 90 wt % of steviosides), 1%;
NHDC, 0.03%;
inulin, 8.97%; and
modified starch, 10%.

The weighted raw materials were mixed, stirred, crushed to 60 meshes and then packaged.

### Embodiment 3

A total of 1000 kg sweetener composition was formulated. Raw materials were weighted according to the following weight percentages:
a Luo Han Guo fruit extract (containing 80 wt % of mogroside V), 30%;
a sweet stevia extract (containing 70 wt % of steviosides), 40%;
NHDC, 0.05%;
inulin, 24.95%; and
Vitamin C, 5%.

The weighted raw materials were mixed, stirred, crushed to 50 meshes, and then packaged.

### Embodiment 4

I. Preparation of Sweetener Composition
A total of 1000 kg sweetener composition was formulated. Raw materials were weighted according to the following weight percentages:
   a Luo Han Guo fruit extract (containing 95 wt % of mogroside V), 10%;
   a sweet stevia extract (containing 80 wt % of steviosides), 10%;
   NHDC, 0.015%;
   inulin, 19.985%;
   modified starch, 40%; and
   a water-soluble dietary fiber, 20%.
The weighted raw materials were mixed, stirred, crushed to 50 meshes, and then packaged.

II. Analysis of Sweetness

1. Experimental Methods and Results
With the sweetness of 5% sucrose solution as a standard, and with steviosides (95 wt %), mogroside V (95 wt %) and the sweetener composition prepared in this embodiment as Sample 1, Sample 2 and Sample 3, the samples were respectively formulated to give a sweetness equivalent to that of 5% sucrose solution, and the sweet tastes of the samples were compared (artificial tasting) with softness, freshness, astringency, bitterness, aftertaste maintenance, irritation, and comprehensive taste as indexes. The obtained sweet taste comparison data is shown in Table 1.

TABLE 1

| | Experimental sample | | | |
|---|---|---|---|---|
| | | | | Sample 3: |
| | | | | sweetener |
| | Standard: | | | composition |
| | 5% sucrose | Sample 1: | Sample 2: | prepared in this |
| Index | solution | steviosides | mogroside V | embodiment |
| Softness | 5 | 6.4 | 4.6 | 6.8 |
| Freshness | 5 | 6.4 | 4.2 | 6.5 |
| Astringency | 5 | 7.2 | 6.5 | 5.3 |
| Bitterness | 5 | 7.8 | 5.6 | 5.4 |
| Aftertaste | 5 | 5.5 | 9.0 | 7.8 |
| Maintenance | | | | |
| Irritation | 5 | 7.7 | 6.0 | 6.5 |
| Comprehensive | 5 | 6.5 | 7.0 | 8.0 |
| taste | | | | |

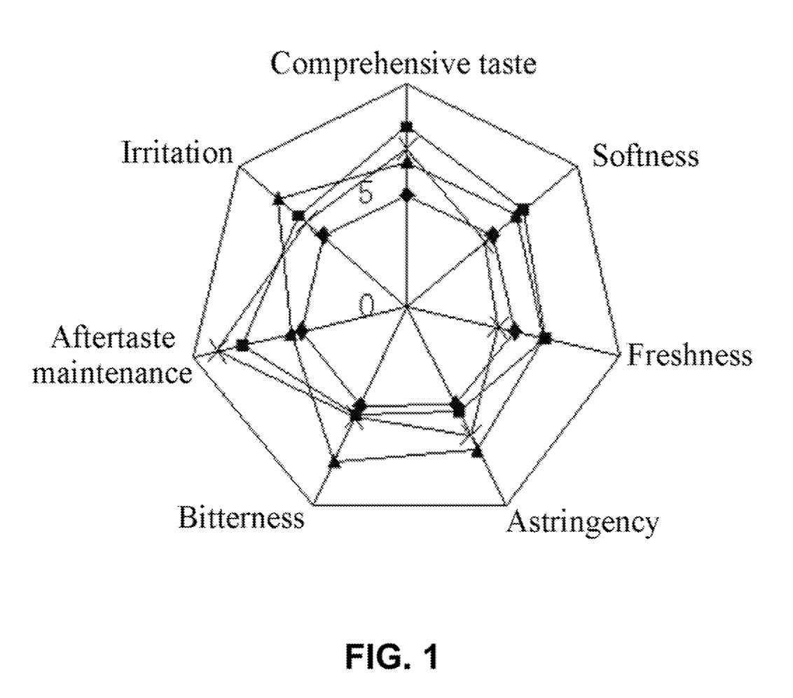

Based on the comparison data in Table 1, a sweet taste analysis diagram is produced and is shown in FIG. 1, where [symbol] represents the standard, [symbol] represents Sample 1, [symbol] represents Sample 2, and [symbol] represents Sample 3.

2. Discussions
As shown in FIG. 1 and Table 1, the indexes of the 5% sucrose solution as the standard are all 5. As for Sample 1 (with steviosides as the sweetener), the softness and freshness indexes are high, but the bitterness, astringency and irritation indexes are especially conspicuous, and are the greatest among the indexes of all the samples; and moreover, the aftertaste maintenance effect is poor, and the index is slightly higher than that of the standard and is the lowest as compared with the other two samples; therefore, the comprehensive taste is slightly better than that of the standard, but still the worst as far as the three samples are concerned.
As for Sample 2 (with mogroside V as the sweetener), the softness and freshness indexes are slightly lower than those of the standard, and the bitterness, astringency and irritation indexes are slightly greater than those of the standard, but are greatly reduced, compared with Sample 1; the bitterness index is low, and is slightly higher than that of the standard, and moreover, the aftertaste maintenance effect is very good, so the comprehensive taste of the sample is improved to a certain extent. Therefore, the comprehensive taste of the sample is better than that of the standard, and is moderate as far as the three samples are concerned.
As for Sample 3 (with the composition prepared as the sweetener according to one embodiment of the present invention), the softness and freshness indexes are the highest among the indexes of all the experimental samples, and the bitterness and astringency indexes are both low, and are only slightly higher than those of the standard; the aftertaste maintenance effect is not the best among those of the experimental samples, but is merely lower than that of Sample 2; the irritation index is slightly greater than that of Sample 2, but the other positive indexes (such as the softness, the freshness, and the aftertaste maintenance) of the sample are all great. Therefore, the comprehensive taste of the sample is the best as far as all the experimental samples are concerned.
As shown in FIG. 1, the data in Table 1 and the analysis above that, the sweetener composition according to one embodiment of the present invention, formulated based on a scientific and sound mixing ratio, can successfully suppress bitterness, astringency, irritation of steviosides in the sweet stevia extract and Chinese herbal medicine taste of the Luo Han Guo fruit extract by using the bitterness suppressing characteristic of NHDC while fully exerting the soft and fresh taste of steviosides in the ingredient sweet stevia extract and the aftertaste maintenance effect of mogroside V in the ingredient Luo Han Guo fruit extract. Therefore, the sweetener composition of the present invention is a sweetener prepared with natural plant extracts as raw materials, having low calorie value, high sweetness, good taste and no toxic side effects, and is especially suitable for the food industry.

### Embodiment 5

A total of 1000 kg sweetener composition was prepared. Raw materials were weighted according to the following weight percentages:
a Luo Han Guo fruit extract (containing 50 wt % of mogroside V), 20%;
a sweet stevia extract (containing 60 wt % of steviosides), 15%;
NHDC, 0.01%;
inulin, 14.99%;
a water-soluble dietary fiber, 47%; and
citric acid, 3%.

The weighted raw materials were mixed, stirred, crushed to 30 meshes, and then packaged.

1. A sweetener composition, based on the weight percentage, comprising:
a Luo Han Guo fruit extract, 0.1-80%;
a sweet stevia extract, 0.1-60%;
neohesperidin dihydrochalcone (NHDC), 0.001-0.05%; and
an adjuvant, 1-80%,
wherein the weight content of the Luo Han Guo fruit extract, based on mogroside V, is 1-95%; and the weight content of the sweet stevia extract, based on steviosides, is 50-95%.

2. The sweetener composition according to claim 1, wherein the weight percentages of the ingredients are:
the Luo Han Guo fruit extract, 1-60%;
the sweet stevia extract, 1-40%;
NHDC, 0.001-0.03%; and
the adjuvant, 10-80%.

3. The sweetener composition according to claim 2, wherein the weight percentages of the ingredients are:
the Luo Han Guo fruit extract, 5-30%;
the sweet stevia extract, 3-25%;
NHDC, 0.001-0.02%; and
the adjuvant, 45-80%.

4. The sweetener composition according to claim 3, wherein the weight percentages of the ingredients are:
the Luo Han Guo fruit extract, 20%;
the sweet stevia extract, 15%;
NHDC, 0.01%; and
the adjuvant, 64.99%.

5. The sweetener composition according to claim 4, wherein the adjuvant comprises at lease one of inulin, modified starch, and water-soluble dietary fiber.

6. The sweetener composition according to claim 5, wherein the adjuvant further comprises at least one of citric acid, Vitamin C, sugar alcohol and spices.

7. The sweetener composition according to claim 1, wherein the adjuvant comprises at lease one of inulin, modified starch, and water-soluble dietary fiber.

8. The sweetener composition according to claim 7, wherein the adjuvant further comprises at least one of citric acid, Vitamin C, sugar alcohol and spices.

9. The sweetener composition according to claim 2, wherein the adjuvant comprises at lease one of inulin, modified starch, and water-soluble dietary fiber.

10. The sweetener composition according to claim 9, wherein the adjuvant further comprises at least one of citric acid, Vitamin C, sugar alcohol and spices.

11. The sweetener composition according to claim 3, wherein the adjuvant comprises at lease one of inulin, modified starch, and water-soluble dietary fiber.

12. The sweetener composition according to claim 11, wherein the adjuvant further comprises at least one of citric acid, Vitamin C, sugar alcohol and spices.
